(19) United States
(12) Patent Application Publication
(10) Pub. No.: US 2022/0173507 A1
(43) Pub. Date: Jun. 2, 2022

(54) DUAL-POLARIZED RADIATING ELEMENTS FOR BASE STATION ANTENNAS HAVING BUILT-IN STALK FILTERS THAT BLOCK COMMON MODE RADIATION PARASITICS

(71) Applicant: CommScope Technologies LLC, Hickory, NC (US)

(72) Inventor: Mohammad Vatankhah VARNOOSFADERANI, Plano, TX (US)

(21) Appl. No.: 17/437,362

(22) PCT Filed: Mar. 17, 2020
(86) PCT No.: PCT/US2020/023124

§ 371 Date: Sep. 8, 2021

Related U.S. Application Data
(60) Provisional application No. 62/822,387, filed on Mar. 22, 2019.

(51) Int. Cl. H01Q 1/52; H01Q 21/06

(52) U.S. Cl. CPC H01Q 1/523; H01Q 21/062

(57) ABSTRACT

An antenna includes a radiator and a feed stalk electrically coupled by first and second feed paths to the radiator. The feed stalk includes a common-mode rejection filter, which has first and second ports electrically connected to the first and second feed paths, a first inductor electrically coupled to the first port and a second inductor electrically coupled to the second port. The common-mode rejection filter is configured so that a first impedance electrically coupled to the first port is equivalent to Z₁, and a second impedance electrically coupled to the second port is equivalent to Z₂, where: Z₁=R₁+jωL+jωM(I₂/I₁); Z₂=R₂+jωL₂+jωM(I₁/I₂); M≈L₁≈L₂; R₁ and R₂ are the resistances of the first and second inductors; L₁ and L₂ are the inductances of the first and second inductors; M is a mutual inductance between the first and second inductors; I₁ and I₂ are the first and second currents into the first and second ports; and ω is the angular frequency of the first and second currents.

### FIELD OF THE INVENTION

The present invention relates to radio communications and antenna devices and, more particularly, to dual-polarized antennas for cellular communications and methods of operating same.

### BACKGROUND

Cellular communications systems are well known in the art. In a typical cellular communications system, a geographic area is often divided into a series of regions that are commonly referred to as “cells”, which are served by respective base stations. Each base station may include one or more base station antennas (BSAs) that are configured to provide two-way radio frequency (“RF”) communications with mobile subscribers that are within the cell served by the base station. In many cases, each base station is divided into “sectors.” In perhaps the most common configuration, a hexagonally shaped cell is divided into three 120° sectors, and each sector is served by one or more base station antennas, which can have an azimuth Half Power Beam Width (HPBW) of approximately 65° to thereby provide sufficient coverage to each 120° sector. Typically, the base station antennas are mounted on a tower or other raised structure and the radiation patterns (a/k/a “antenna beams”) are directed outwardly therefrom. Base station antennas are often implemented as linear or planar phased arrays of radiating elements.

Furthermore, in order to accommodate an increasing volume of cellular communications, cellular operators have added cellular service in a variety of frequency bands. While in some cases it is possible to use a single linear array of so-called “wide-band” radiating elements to provide service in multiple frequency bands, in other cases it may be necessary to use different linear arrays of radiating elements in multi-band base station antennas to support service in the additional frequency bands.

One conventional multi-band base station antenna design includes at least one linear array of relatively “low-band” radiating elements, which can be used to provide service in some or all of a 617-960 MHz frequency band. In addition, to reduce costs and provide for more compact antennas, each of these “low-band” radiating elements may be configured to surround a corresponding relatively “high band” radiating element that is used to provide service in some or all of a 1695-2690 MHz frequency band.

A conventional box dipole radiating element may include four dipole radiators that are arranged to define a box Ike shape. The four dipole radiators may extend in a common plane, and may be mounted forwardly of a reflector that may extend parallel to the common plane. So called feed stalks may be used to mount the four dipole radiators forwardly from the reflector, and may be used to pass RF signals between the dipole radiators and other components of the antenna. In some of these conventional box dipole radiating elements, a total of eight feed stalks (4×2) may be provided and may connect to the box dipole radiators at the corners of the box.

For example, as illustrated by FIGS. 1A-1B, a conventional multi-band radiator 10 for a base station antenna may include a relatively high-band radiating element 10a centered within and surrounded on four sides by a relatively low-band radiating element 10b, which is configured as a box dipole radiating element (“box dipole”). RF signals may be fed to the four dipole radiators of a conventional box dipole radiator element through the feed stalks at two opposed and “excited” corners of the “box,” as is shown in FIG. 1A, In response, common mode (CM) currents are forced automatically onto the two diametrically opposed non-excited corners of the box, in response to differential mode (DM) currents that are fed to the two excited “differential mode” ports. And, because these common mode currents radiate as a monopole on these “non-excited” feed stalks, the overall radiation pattern of the box dipole 10b is actually a combination of two dipoles and two monopoles (with “nulls”), as illustrated by the simplified radiation patterns of FIG. 1B. Unfortunately, the radiation stemming from monopole operation can be highly undesirable when designing a box dipole radiator. For example, although having common mode currents radiating at the same time with differential mode currents in the box dipole 10b can be expected to slightly narrow the azimuth HPBW of the box dipole 10b because of the presence of two nulls caused by the monopole radiators, a concurrent co-polarization radiation pattern of the box dipole 10b can be expected to demonstrate rising “shoulders” in the radiation pattern, which can significantly degrade overall antenna performance.

Referring now to FIGS. 2A-2B, conventional cross-polarized box dipole radiating elements 20, 20′ (with inwardly slanted feed stalks and hence slanted monopoles) are illustrated, which operate in a similar manner relative to the low-band radiating element 10b of FIG. 1A. Thus, as shown, the excitation of a first pair of diametrically opposite “differential mode” ports of the box dipole radiating elements 20, 20′ can induce common mode (CM) currents in a corresponding second pair of ports, which results in monopole-type radiation from a pair of slanted monopoles. And, as further shown by FIG. 2A, this monopole-type radiation can result in the generation of undesired “shoulders” (S) in an azimuth radiation pattern associated with the box dipole 20.

### SUMMARY

Dual-polarized radiating elements for base station antennas (BSAs) may utilize stalk-based filters to suppress common mode radiation parasitics. According to some embodiments of the invention, an antenna radiating element is provided with first and second radiator arms, which may be supported in front of a substrate by a feed stalk. This feed stalk includes a first feed path electrically coupled to the first radiator arm, a second feed path electrically coupled to the second radiator arm, and a common-mode rejection filter having first and second ports electrically connected to the first and second feed paths, respectively. This common-mode rejection filter includes a pair of coupled inductors therein. In some embodiments of the invention, the pair of coupled inductors may be disposed intermediate a base and distal end of the feed stalk.

The pair of coupled inductors includes: (i) a first inductor having a current carrying terminal electrically coupled to the first port of the common-mode rejection filter, and (ii) a second inductor having a current carrying terminal electrically coupled to the second port of the common-mode rejection filter. The feed stalk may also be configured as a printed circuit board having patterned metallization on first and second opposing sides thereof, and the pair of coupled inductors may be defined by the patterned metallization on the first and second opposing sides of the printed circuit board. In addition, the first feed path may be electrically connected to the first of the pair of coupled inductors, and the second feed path may be electrically connected by a plated through-hole in the printed circuit board to the second of the pair of coupled inductors.

According to additional embodiments of the invention, the common-mode rejection filter is configured so that a first impedance electrically coupled to the first port is equivalent to Z₁, and a second impedance electrically coupled to the second port is equivalent to Z₂, where: Z₁=+jωL₁+jωM(I₂/I₁), Z₂=R₂+jωL₂ jωM(I₁/I₂), R₁ and R₂ are the resistances of the first inductor and the second inductor, respectively; L₁ and L₂ are the inductances of the first inductor and the second inductor, respectively; M is a mutual inductance between the first and second inductors; I₁ and I₂ are the first and second currents into the first and second ports, respectively; and ω is the angular frequency of the first and second currents. These impedances Z₁ and Z₂ are configured to block common mode signals with high frequency-dependent reactances when I₁ equals I₂, but selectively and efficiently pass differential mode signals with a very low resistance when I₁ equals −I₂.

In further embodiments of the invention, the antenna is configured as a box dipole antenna having first through fourth feed ports that communicate with respective first through fourth corners of the box dipole. A first feed port is provided at a first corner, and is electrically coupled by the common-mode rejection filter to the first and second feed paths. In other embodiments of the invention, the antenna is configured as a loop antenna having at least a first feed port, which is electrically coupled by the common-mode rejection filter to the first and second feed paths.

According to additional embodiments of the invention, a box dipole antenna is provided, which includes a first dipole radiator having first and second dipole arms electrically coupled to respective first and second ports of a first common-mode rejection filter. The first common-mode rejection filter is configured so that a first impedance therein, which is electrically coupled to the first port, is equivalent to and a second impedance therein, which is electrically coupled to the second port, is equivalent to Z₂, where: Z₁=+jωL₁+jωM(I₂/I₁), Z₂=R₂+jωL₂ jωM(I₁/I₂), and R₂ are the resistances of a first inductor and a second inductor, respectively; L₁ and L₂ are the inductances of the first inductor and the second inductor, respectively; M is a mutual inductance between the first and second inductors; I₁ and I₂ are the first and second currents into the first and second ports, respectively; and ω is the angular frequency of the first and second currents. In addition, the first common-mode rejection filter may be integrated into a first feed stalk, which is: (i) electrically coupled to a first end of the first dipole arm and a first end of the second dipole arm, and (ii) supports the first dipole radiator in front of a substrate, such as a ground plane reflector of a base station antenna.

According to still further embodiments of the invention, an antenna is provided, which includes a radiator (e.g., loop, box dipole, etc.) and a feed stalk. This feed stalk, which is electrically coupled by first and second feed paths to the radiator, includes a common-mode rejection filter having first and second ports electrically connected to the first and second feed paths, respectively. In some of these embodiments of the invention, the common-mode rejection filter includes a pair of coupled inductors therein, which may be disposed intermediate a base and a distal end of the feed stalk. This pair of inductors includes a first inductor having a first current carrying terminal electrically coupled to the first port of the common-mode rejection filter, and a second inductor having a first current carrying terminal electrically coupled to the second port of the common-mode rejection filter.

In some of these embodiments of the invention, the feed stalk may include a printed circuit board having patterned metallization on first and second opposing sides thereof, and the pair of coupled inductors may be at least partially defined by the patterned metallization on the first and second opposing sides of the printed circuit board. In addition, the first feed path may be electrically connected to the first of the pair of coupled inductors, whereas the second feed path may be electrically connected by a plated through-hole in the printed circuit board to the second of the pair of coupled inductors.

### BRIEF DESCRIPTION OF THE DRAWINGS

FIG. 1A is a schematic diagram of a multi-band radiator including a high-band radiating element surrounded by a low-band box dipole radiating element, showing simulated differential mode and common mode currents therein, according to the prior art.

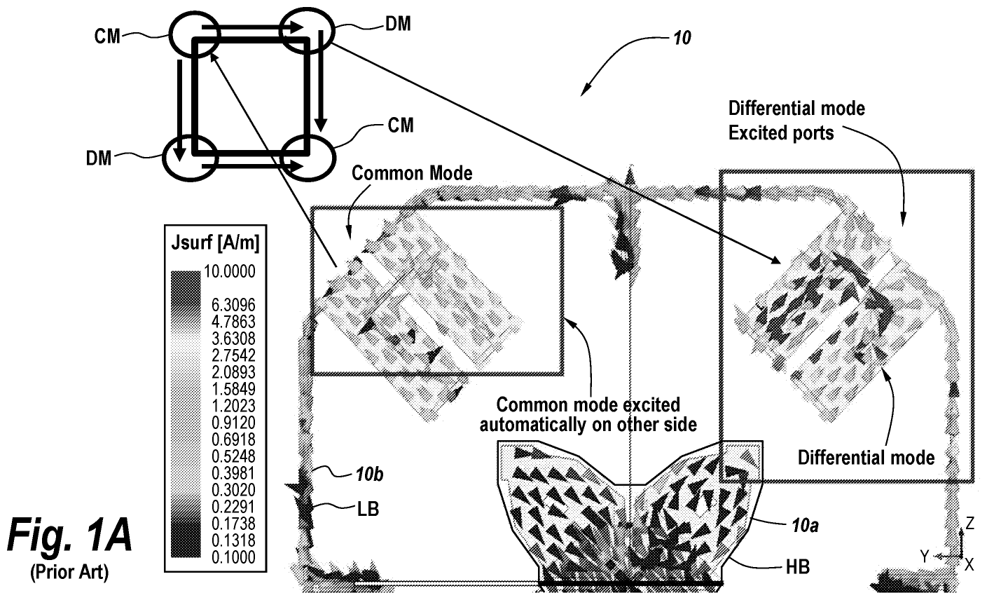

FIG. 1B illustrates differential mode (DM) and common mode (CM) radiation patterns for a box dipole antenna, according to the prior art.

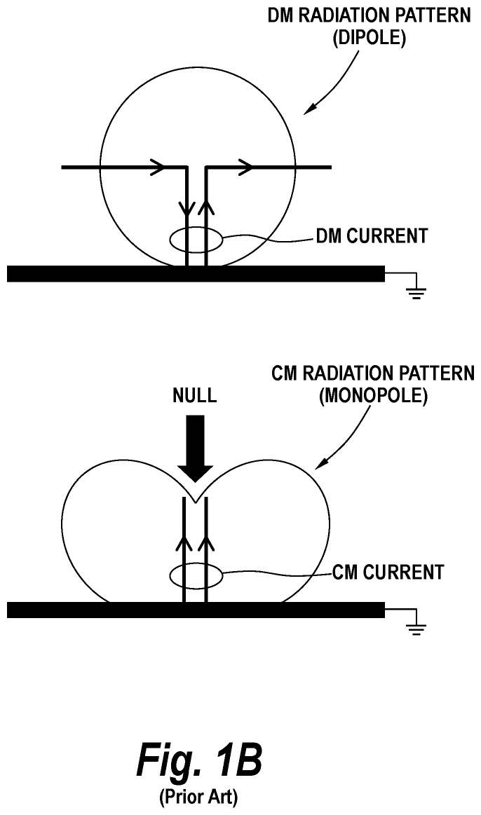

FIG. 2A illustrates a conventional box dipole radiating element with slanted monopoles, and a simulated azimuth radiation pattern having undesired shoulders.

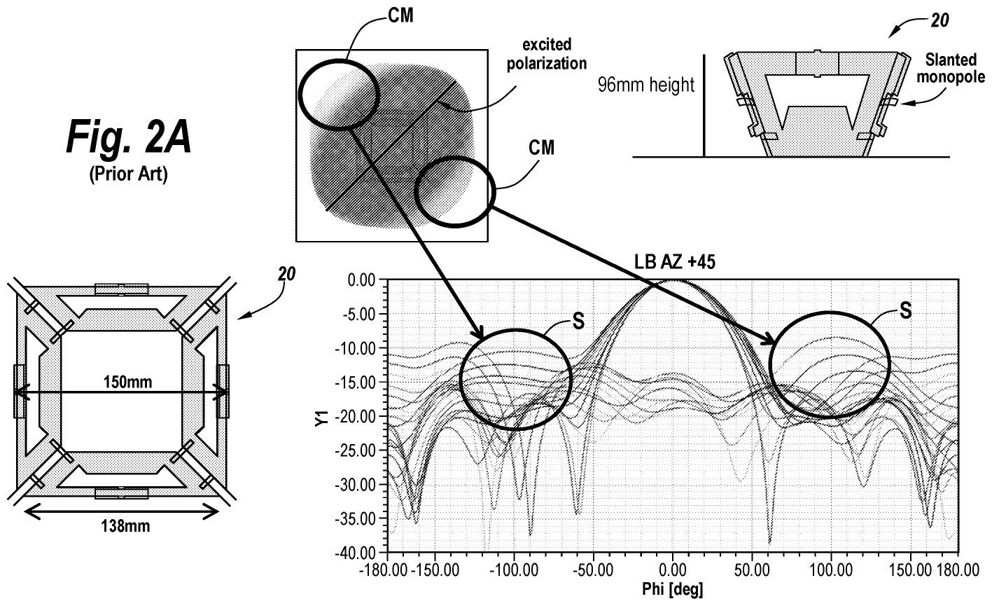

FIG. 2B illustrates a conventional sheet metal box dipole radiating element with slanted monopoles, and a simulated radiation pattern that highlights undesired shoulders.

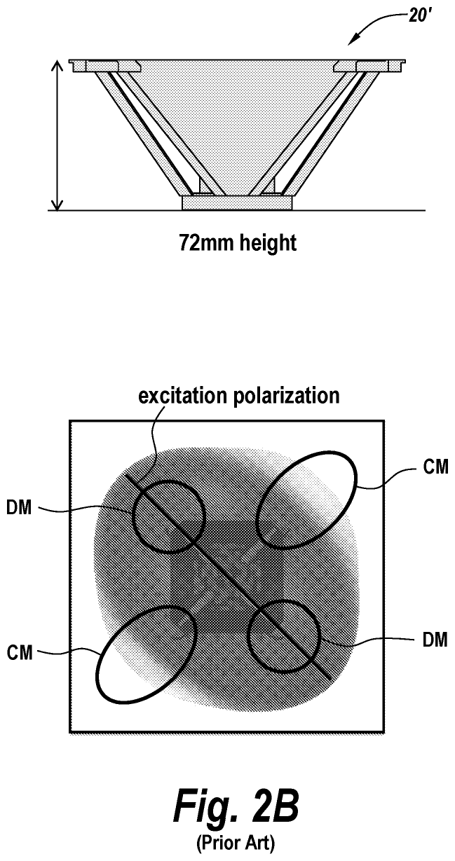

FIG. 3A is perspective view of a loop antenna with feed stalks containing common-mode rejection filters, according to an embodiment of the present invention.

FIG. 3B is a perspective view of a feed stalk including a multi-layer printed circuit board (PCB), according to an embodiment of the present invention.

FIG. 3C is a front view of the feed stalk of FIG. 3B, which illustrates patterned metallization on a front side of a printed circuit board, according to an embodiment of the invention.

FIG. 3D is a front view of the feed stalk of FIG. 3B, but will all patterned metallization on the front side of the printed circuit board removed and only patterned metallization on a rear side of the printed circuit board visible (looking through the PCB), according to an embodiment of the present invention.

FIG. 3E is a front view of the printed circuit board of the feed stalk of FIG. 3B, which reveals a pair of plated through-holes, according to an embodiment of the present invention.

FIG. 3F is a perspective view of the feed stalk of FIG. 3B, but assuming a transparent printed circuit board for purposes of illustration so that current paths associated with the common-mode rejection filter can be illustrated, according to an embodiment of the invention.

FIG. 4 is a top-down plan view of a box dipole antenna that utilizes four of the feed stalks of FIGS. 3B-3F, according to an embodiment of the present invention.

### DETAILED DESCRIPTION OF EMBODIMENTS

The present invention now will be described more fully with reference to the accompanying drawings, in which preferred embodiments of the invention are shown. This invention may, however, be embodied in many different forms and should not be construed as being limited to the embodiments set forth herein; rather, these embodiments are provided so that this disclosure will be thorough and complete, and will fully convey the scope of the invention to those skilled in the art. Like reference numerals refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed hereinbelow can be combined in any way and/or combination with aspects or elements of other embodiments to provide a plurality of additional embodiments.

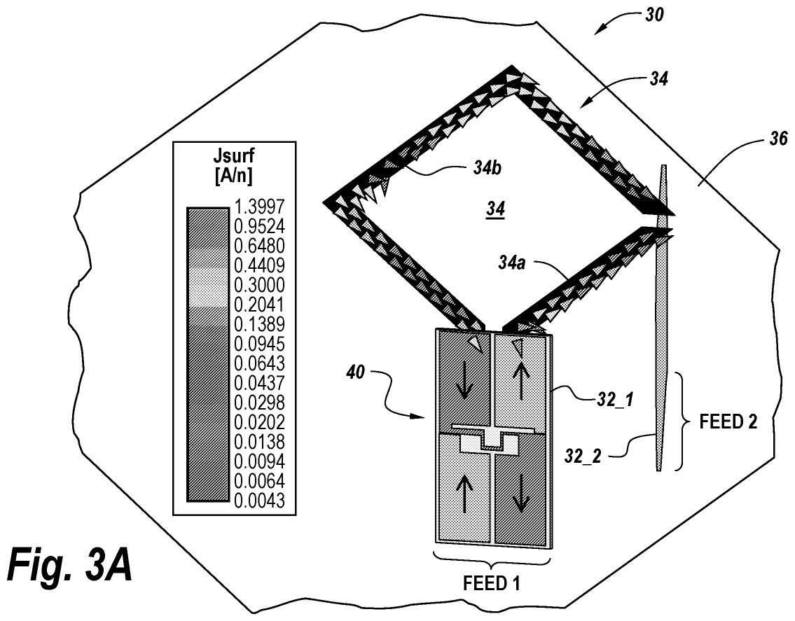

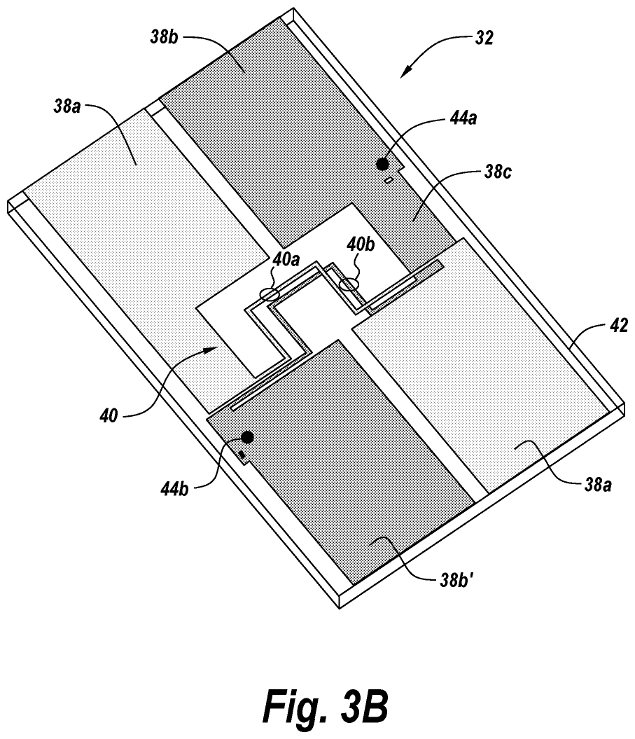

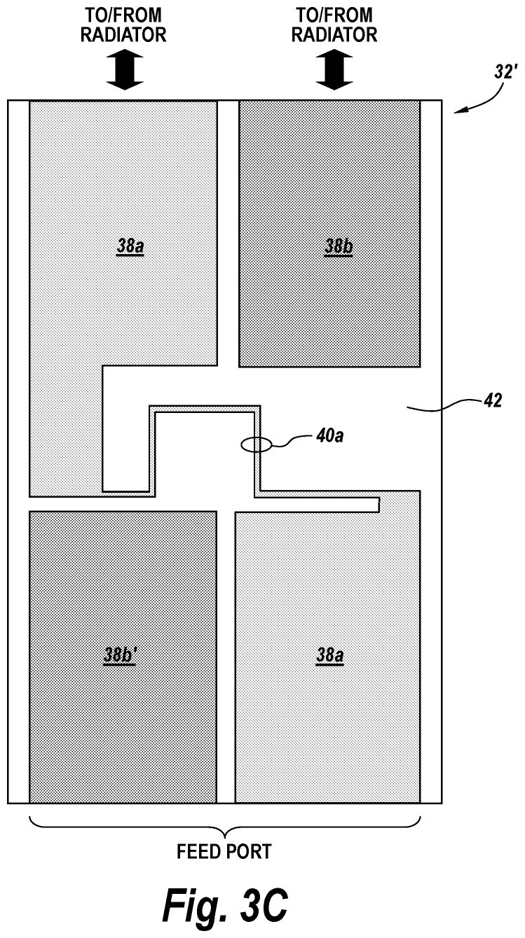

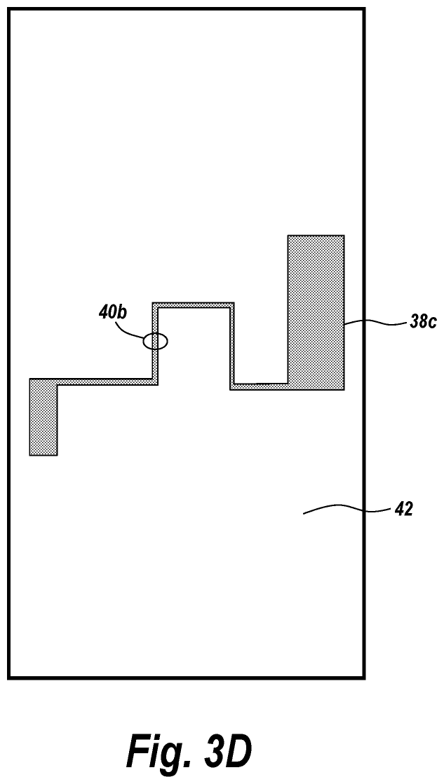

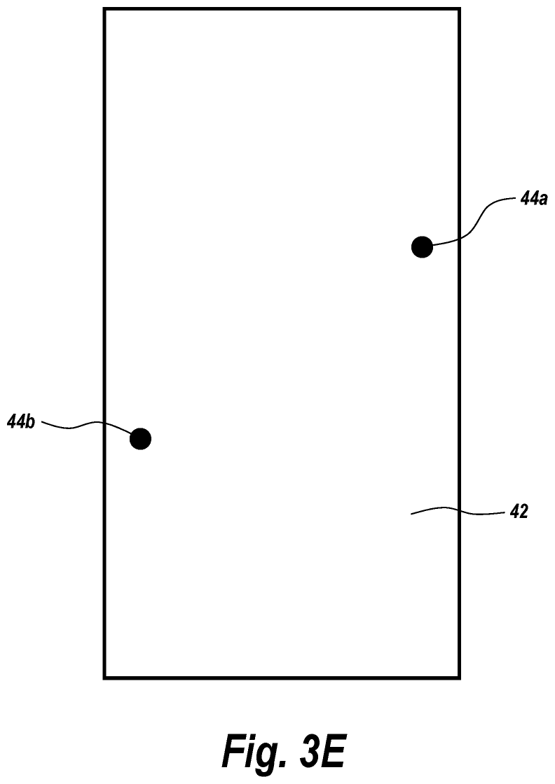

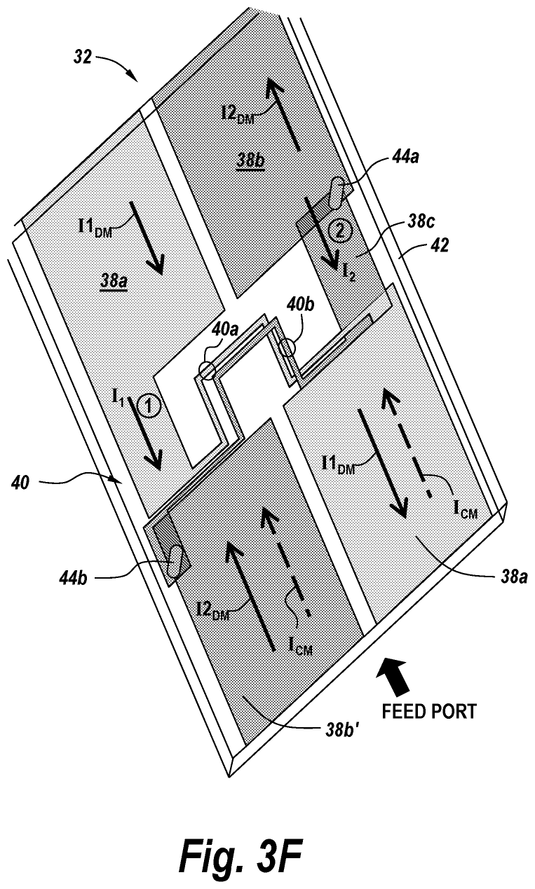

Referring now to FIG. 3A, an antenna 30 according to an embodiment of the invention is illustrated as including a shared single-sided radiator segment 34a and a shared three-sided radiator segment 34b, which extend along four sides of a rectangular (e.g., square) loop 34. As shown, this rectangular loop 34 is supported in front of a reflector surface 36, such as a ground plane, by a pair of “dual-path” feed stalks 32_1, 32_2. These feed stalks 32_1, 32_2, which are each electrically coupled to respective ends of the radiator segments 34a, 34b, enable operation of the rectangular loop 34 as a cross-polarized loop antenna. For example, when operating as an RF transmitter, the rectangular loop 34 is responsive to first and second “outgoing” radio frequency (RF) signals, which are provided to first and second feed ports FEED1, FEED2 at the base of the feed stalks 32_1, 32_2. Alternatively, when operating as a receiver of RF signals, the rectangular loop 34 receives and passes relatively low energy RF signals to the feed stalks 32_1, 32_2, which are electrically coupled at the first and second feed ports FEED1, FEED2 to low noise amplification and receiver circuitry (not shown). In some embodiments of the invention, the rectangular loop 34 may be a relatively small square loop with each side spanning about ¼ of the wavelength for the operating frequency of the antenna.

Referring now to FIGS. 3B-3F, each of the feed stalks 32_1, 32_2 utilized by the loop antenna of FIG. 3A may be configured as identical multi-layer printed circuit board (PCB) feed stalks 32. However, in alternative embodiments of the invention, it may be advantageous (e.g., for isolation or pattern tuning purposes) to have feed stalks with different impedances to thereby support unbalanced polarizations. In particular, and as shown by FIG. 3B, the feed stalk 32 may include a dielectric (i.e., non-conductive) board substrate 42 having patterned metallization on first and second opposing sides thereof. On the first side, a first electrically conductive path 38a is provided, which includes a continuous metallization path that extends from one corner at a first “distal” end of the substrate 42 to a diametrically opposite corner on a second end (e.g., base) of the substrate 42, as illustrated. In addition, a second electrically conductive path is defined by patterned metal segments 38b, 38b′ and 38c and a pair of electrically conductive (e.g., plated) through-holes 44a, 44b, which electrically connect “intermediate” segment 38c to respective segments 38b and 38b′.

As shown more fully by FIGS. 3C-3E, a first side 32′ of the feed stalk 32 includes a serpentine-shaped inductor 40a, which extends in series within the first electrically conductive path 38a (without interruption) and at a location intermediate the ends of the substrate 42, as shown. In addition, the patterned metal segments 38b, 38b′ on the first side 32′ of the feed stalk 32, the two plated through-holes 44a, 44b, and the patterned metal segment 38c on the second side 32″ of the feed stalk 32, which includes a serpentine-shaped inductor 40b therein, collectively define a second electrically conductive path that extends between diametrically opposite corners of the feed stalk 32, as shown. According to alternative embodiments of the invention, the first and second electrically conductive paths (including inductors 40a, 40b) may be provided in the absence of a dielectric board substrate.

As will now be described more fully with respect to FIGS. 3B and 3F, the first and second serpentine-shaped inductors 40a, 40b, which extend on opposing first and second sides of the printed circuit board substrate 42, collectively define a common-mode rejection (CMR) filter 40 that selectively and advantageously blocks common mode currents I_{CM} from passing from a feed port at the base of a feed stalk 32 to the radiator segments 34a, 34b within the rectangular loop 34, which are mounted to a distal end of the feed stalk 32 and electrically connected to respective ones of the first electrically conductive path 38a and patterned metal segment 38b at the distal end. For example, with respect to the first feed port (FEED1) illustrated by FIG. 3A, the CMR filter 40 blocks a common mode current I_{CM} from passing to a distal portion of the first feed path 38a, which is directly connected to the three-sided radiator segment 34b, and blocks a common mode current I_{CM} from passing to a distal portion of the second feed path 38b, which is directly connected to the one-sided radiator segment 34a. Likewise, with respect to the second feed port (FEED2), the CMR filter 40 blocks a common mode current I_{CM} from passing to a distal portion of the first feed path 38a, which is directly connected to the one-sided radiator segment 34a, and blocks a common mode current I_{CM} from passing to a distal portion of the second feed path 38b, which is directly connected to the three-sided radiator segment 34b.

These preferential RF “blocking” characteristics of the CMR filter 40 can be best understood by considering how a specific mutual inductance M between the overlapping serpentine-shaped inductors 40a, 40b, which are separated by a PCB substrate 42 having a predetermined thickness, can be designed to block common mode currents at a first RF frequency, yet selectively pass (with very low attenuation) differential-mode currents at the same RF frequency.

Although not wishing to be bound by any theory, the first inductor 40a on the first side 32′ of the substrate 42 may be treated as having an impedance Z₁, and the second inductor 40b on the second side 32″ of the substrate 42 may be treated as having an impedance Z₂, where:

Z₁=R₁+jωL₁+jωM(I₂/I₁); and

Z₂=R₂+jωL₂+jωM(I₁/I₂).

In these equations, R₁ and R₂ are the resistances of the first inductor 40a and the second inductor 40b, respectively; L₁ and L₂ are the inductances of the first inductor 40a and the second inductor 40b, respectively; M is a mutual inductance between the overlapping first and second inductors 40a, 40b, which are separated from each other by the electrically insulating PCB substrate 42; I₁ and I₂ are the first and second currents into the first and second ports (1) and (2) of the filter 40, respectively; and ω is the angular frequency of the first and second currents. As shown by FIG. 3F, a first differential mode current I1_{DM}, which passes from a distal portion of the first feed path 38a to a base of the first feed path 38a at the feed port, is treated herein as equivalent to I₁, whereas I2_{DM}, which passes from a base portion (metal segment 38b′) of the second feed path (at the feed port) to a distal portion (metal segment 38b) of the second feed path, is treated herein as equivalent to −I₂.

By carefully designing/tuning the inductors L₁ and L₂ (and their coupling) to be equivalent to each other and equivalent to the mutual inductance M between them (i.e., L₁≈L₂≈M, where the expression “≈” designates an equality within ±10%), and assuming I₂=−I₁ with respect to the differential mode currents I1_{DM} and I2_{DM} shown in FIG. 3F, then the impedances of the first and second inductors 40a, 40b may be treated as equivalent to:

Z₁=R₁+jω(L₁−M)≈R₁; and

Z₂=R₂+jω(L₂−M)≈R₂.

Thus, because R₁ and Z₂≈R₂, the common-mode rejection filter 40 presents a low resistive impedance to differential mode current, and this low impedance is equal to the DC resistance of the inductors L₁ and L₂. However, assuming I₂=I₁ with respect to the common mode currents I_{CM} shown in FIG. 3F, then the impedances of the first and second inductors 40a, 40b present a high (and frequency dependent) inductive impedance at common mode to thereby block common mode currents, where:

Z₁=+jω(L₁+M)+jω×2L; and

Z₂=R₂+jω(L₂+M)≈R₂+jω×2L.

Accordingly, the stalk-based common-mode rejection filter 40 may be utilized advantageously to block common mode currents from passing through the feed stalks 32_1 and 32_2 and thereby inhibit monopole-type radiation from the loop radiator 34 of FIG. 3A, which might otherwise occur on these feed stalks.

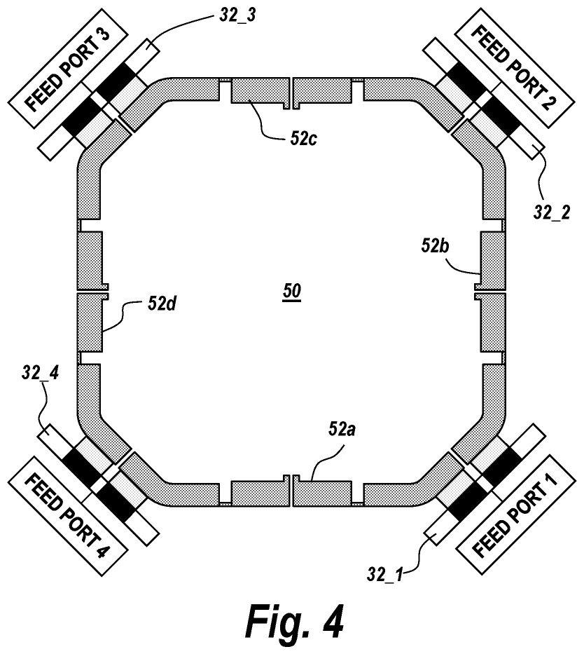

According to further embodiments of the invention, the feed stalk 32 and common-mode rejection filter 40 described hereinabove may be applied to many other antenna designs that may benefit from monopole-type radiation suppression resulting from the generation of common-mode currents within radiating elements. For example, as illustrated by FIG. 4, a box dipole antenna 50 (e.g., sheet metal box dipole antenna) may be provided having four “shared” dipole radiating elements 52a-52d, which collectively form four dipole radiators. A first dipole radiator is defined by radiating elements 52a, 52b, which are electrically coupled to a first feed stalk 32_1 and first feed port coupled to a base of the first feed stalk 32_1, as illustrated by FIGS. 3B-3F. Similarly, a second dipole radiator is defined by radiating elements 52b, 52c, which are electrically coupled to a second feed stalk 32_2 and a second feed port. A third dipole radiator is defined by radiating elements 52c, 52d, which are electrically coupled to a third feed stalk 32_3 and a third feed port. Finally, a fourth dipole radiator is defined by radiating elements 52d, 52a, which are electrically coupled to a fourth feed stalk 32_4 and a fourth feed port. As described hereinabove with respect to the “loop” antenna 30 of FIGS. 3A-3F, the first through fourth feed stalks 32_1 through 32_4 will enable differential mode operation on each excited port of the box dipole antenna 50, yet efficiently block common mode currents (and corresponding monopole radiation) on ports associated with an opposite polarization relative to each excited port. And, according to other embodiments of the invention, the feed stalks described hereinabove may be applied to rectangular-shaped box dipole antennas, and antennas with dipole radiating elements having unequal lengths and/or spacing therebetween. In addition, the feed stalks and inductively-coupled feed paths described herein can be used advantageously in many antenna designs in which a differential mode signal is desired and a common mode signal is not desired such as, but not limited to, dipole-type antennas.

In the drawings and specification, there have been disclosed typical preferred embodiments of the invention and, although specific terms are employed, they are used in a generic and descriptive sense only and not for purposes of limitation, the scope of the invention being set forth in the following claims.

1. An antenna, comprising:
a radiator including first and second radiator arms supported in front of a substrate by a feed stalk, said feed stalk comprising a first feed path electrically coupled to the first radiator arm, a second feed path electrically coupled to the second radiator arm, and a common-mode rejection filter having first and second ports electrically connected to the first and second feed paths, respectively.

2. The antenna of claim 1, wherein the common-mode rejection filter comprises a pair of mutually-coupled inductors therein.

3. The antenna of claim 2, wherein the pair of mutually-coupled inductors are positioned intermediate a base and distal end of the feed stalk.

4. The antenna of claim 2, wherein the pair of mutually-coupled inductors comprises a first inductor having a first current carrying terminal electrically coupled to the first port of the common-mode rejection filter, and a second inductor having a first current carrying terminal electrically coupled to the second port of the common-mode rejection filter.

5. The antenna of claim 3, wherein the feed stalk comprises a printed circuit board having patterned metallization on first and second opposing sides thereof; and wherein the pair of mutually-coupled inductors are at least partially defined by the patterned metallization on the first and second opposing sides of the printed circuit board.

6. The antenna of claim 3, wherein the feed stalk comprises a printed circuit board; wherein the pair of mutually-coupled inductors includes a first inductor and a second inductor; wherein the first inductor is at least partially defined by patterned metallization on a first side of the printed circuit board; and wherein the second inductor is at least partially defined by patterned metallization on a second side of the printed circuit board, opposite the first side.

7. The antenna of claim 6, wherein the first feed path is electrically connected to the first inductor; and wherein the second feed path is electrically connected by a plated through-hole in the printed circuit board to the second inductor.

8. The antenna of claim 2, wherein the feed stalk comprises a printed circuit board having patterned metallization on first and second opposing sides thereof; and wherein the pair of mutually-coupled inductors are at least partially defined by the patterned metallization on the first and second opposing sides of the printed circuit board.

9. The antenna of claim 2, wherein the feed stalk comprises a printed circuit board; wherein the pair of mutually-coupled inductors includes a first inductor and a second inductor; wherein the first inductor is at least partially defined by patterned metallization on a first side of the printed circuit board; and wherein the second inductor is at least partially defined by patterned metallization on a second side of the printed circuit board, opposite the first side.

10. The antenna of claim 9, wherein the first feed path is electrically connected to the first inductor; and wherein the second feed path is electrically connected by a plated through-hole to the second inductor.

11. The antenna of claim 4, wherein the common-mode rejection filter is configured so that a first impedance electrically coupled to the first port is equivalent to Z₁, and a second impedance electrically coupled to the second port is equivalent to Z₂, where: Z₁=R₁+jωL₁+jωM(I₂/I₁); Z₂=R₂+jωL₂+jωM(I₁/I₂); R₁ and R₂ are the resistances of the first inductor and the second inductor, respectively; L₁ and L₂ are the inductances of the first inductor and the second inductor, respectively; M is a mutual inductance between the first and second inductors; I₁ and I₂ are the first and second currents into the first and second ports, respectively; and ω is the angular frequency of the first and second currents.

12.-23. (canceled)

24. An antenna, comprising:
a radiator; and
a feed stalk comprising a common-mode rejection filter having first and second ports electrically connected to first and second radiating elements within said radiator, respectively.

25. The antenna of claim 24, wherein the common-mode rejection filter comprises a pair of mutually-coupled inductors therein.

26. The antenna of claim 25, wherein the pair of mutually-coupled inductors are disposed intermediate a top and bottom of the feed stalk.

27. The antenna of claim 25, wherein the pair of mutually-coupled inductors comprises a first inductor having a first current carrying terminal electrically coupled to the first port of the common-mode rejection filter, and a second inductor having a first current carrying terminal electrically coupled to the second port of the common-mode rejection filter.

28.-30. (canceled)

31. The antenna of claim 25, wherein the feed stalk comprises a printed circuit board having patterned metallization on first and second opposing sides thereof; and wherein the pair of mutually-coupled inductors are at least partially defined by the patterned metallization on the first and second opposing sides of the printed circuit board.

32. The antenna of claim 25, wherein the feed stalk comprises a printed circuit board; wherein the pair of mutually-coupled inductors includes a first inductor and a second inductor; wherein the first inductor is at least partially defined by patterned metallization on a first side of the printed circuit board; and wherein the second inductor is at least partially defined by patterned metallization on a second side of the printed circuit board, opposite the first side.

33. The antenna of claim 32, wherein the first feed path is electrically connected to the first inductor and the second feed path is electrically connected by a plated through-hole to the second inductor.

34.-35. (canceled)

36. An antenna, comprising:
a radiator electrically coupled to respective first and second ports of a common-mode rejection filter disposed in a feed signal path of the antenna, said common-mode rejection filter configured so that a first impedance therein, which is electrically coupled to the first port, is equivalent to Z₁, and a second impedance therein, which is electrically coupled to the second port, is equivalent to Z₂, where: Z₁=R₁+jωL₁+jωM(I₂/I₁), Z₂=R₂+jωL₂+jωM(I₁/I₂); M≈L₁≈L₂; R₁ and R₂ are the resistances of a first inductor and a second inductor, respectively; L₁ and L₂ are the inductances of the first inductor and the second inductor, respectively; M is a mutual inductance between the first and second inductors; I₁ and I₂ are the first and second currents into the first and second ports, respectively; the expression “≈” designates an equality within ±10%; and ω is the angular frequency of the first and second currents.

37.-38. (canceled)

39. The antenna of claim 36, wherein said common-mode rejection filter is integrated into a feed stalk, which is electrically coupled to said radiator; wherein the feed stalk comprises a printed circuit board; wherein the first inductor is at least partially defined by patterned metallization on a first side of the printed circuit board; and wherein the second inductor is at least partially defined by patterned metallization on a second side of the printed circuit board, opposite the first side.

40.-44. (canceled)
